(19) United States
(12) Patent Application Publication
(10) Pub. No.: US 2015/0127372 A1
(43) Pub. Date: May 7, 2015

(54) Electrical Computing Devices Providing Personalized Patient Drug Dosing Regimens

(71) Applicant: Quintiles Transnational Corporation, Durham, NC (US)

(72) Inventor: Nolen Seth Berry, Overland Park, KS (US)

(21) Appl. No.: 14/535,973

(22) Filed: Nov. 7, 2014

Related U.S. Application Data
(60) Provisional application No. 61/901,260, filed on Nov. 7, 2013.

(51) Int. Cl. G06F 19/00

(52) U.S. Cl. CPC G06F 19/3456
USPC 705/2

(57) ABSTRACT

Systems, apparatuses, methods, computer-readable media for providing personalized patient drug dosing regimens are described. One example method includes the steps of receiving, from a non-transitory computer-readable medium, a dosing model for a substance; receiving, from a remote device via a communications network, dosing information for a patient for the substance; updating, by one or more electronic processors, the dosing model based at least in part on the dosing information; executing, by one of the one or more electronic processors, a predictive model based on the updated dosing model to generate a dosing recommendation; and providing, to the remote device via the communications network, the dosing recommendation. Another example includes a computer-readable medium with program code stored on it, where the program code is configured to cause a processor to execute such a method.

### CROSS-REFERENCE TO RELATED APPLICATIONS

This claims priority to U.S. Provisional Patent Application No. 61/901,260 filed Nov. 7, 2013, titled “Distributed Computing System Providing Personalized Patient Drug Dosing Regimens,” the entirety of which is hereby incorporated by reference.

### FIELD

The present disclosure generally relates to electrical computing devices providing personalized dosing regimens of pharmaceutical products (e.g., drugs or biologics) for patients.

### BACKGROUND

Selecting a dosing regimen (e.g., amount of drug, administration route, and frequency of administration) of a specific pharmaceutical product (e.g., a drug or biologic) for a patient is based on recommended dosing regimen instructions included on a product label or package insert. The dosing regimen instructions generally explain the amount of a drug a patient should take, the timing of drug administration, and how the patient or healthcare provider should administer the drug (e.g., orally, topically, intravenous); in total, the dosing regimen. The dosing regimen instructions for a patient often are universal regardless of the characteristics of a particular patient.

A provider may adjust the drug dosing regimen of a patient by conducting a follow up evaluation of the patient after the patient uses the particular drug. However, certain drugs have a narrow therapeutic window where they are ineffective or even toxic if the drug concentrations occur outside of these efficacy and safety thresholds. By maintaining drug concentrations within the therapeutic window, providers can improve efficacy of the drug and reduce the risk of a toxicity related event or of no beneficial effect. Getting the correct drug dosing regimen recommendations for a narrow therapeutic window drug based upon a particular patient's characteristics can be challenging.

### SUMMARY

Various examples are described for electrical computing devices providing personalized patient dosing regimens. For example, a suitable method may include the steps of receiving, from a non-transitory computer-readable medium, a dosing model for a substance; receiving, from a remote device via a communications network, dosing information for a patient for the substance; updating, by one or more electronic processors, the dosing model based at least in part on the dosing information; executing, by one of the one or more electronic processors, a predictive model based on the updated dosing model to generate a dosing recommendation; and providing, to the remote device via the communications network, the dosing recommendation. In another example, a computer-readable medium may comprise program code to cause a processor to execute such a method.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example environment for providing personalized patient dosing regimens;

FIG. 2 shows an example computing device for providing personalized patient dosing regimens;

FIG. 3 shows an example method for providing an initial personalized patient dosing regimen;

FIGS. 4a-h show example graphical user interfaces for requesting initial personalized patient dosing regimen;

FIG. 5 shows an example method for providing adjusted personalized patient dosing regimens;

FIGS. 6a-g show example graphical user interfaces for providing an adjusted personalized patient dosing regimen;

FIGS. 7a-b show example graphical user interfaces for requesting a personalized patient dosing regimen; and

FIGS. 8a-b shows an example graphical user interface for requesting or displaying patient records.

### DETAILED DESCRIPTION

Examples are described herein in the context of electrical computing devices providing personalized patient dosing regimens. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

### Illustrative Example Method for Providing Personalized Patient Dosing Regimens

When a doctor prescribes a drug for a patient, she will determine an appropriate dosing schedule for the patient, such as the size of the dose, how often to take a dose, and how many doses to take during a course of treatment. To do so, the doctor will review various patient characteristics, such as age, height, weight, medical history, demographics, laboratory information, on-going medical conditions, other drugs the patient is taking, and other patient information, including other covariate information. She will also review dosing information provided by the drug company for the drug to be prescribed to determine an appropriate dosing schedule for the patient. However, the dosing information provided by the drug company is typically based on information obtained during a clinical trial for the drug. Thus, the dosing information remains static, based on the underlying set of data obtained during the trial.

However, in this illustrative embodiment, the doctor provides information about the patient to a system that generates drug dosing recommendations based on dosing models updated in real-time, or near-real-time, based on data collected from patients using the drug. The doctor receives the initial dosing regimen for the patient and provides it to the patient. Subsequently, after the patient has begun following the regimen, the patient undergoes testing to determine how the drug is interacting with the patient, e.g., by determining pharmacokinetic (“PK”) and pharmacodynamic (“PD”) information, such as to determine drug concentration levels, rates of metabolism, or other effects of the drug on the patient or the patient on the drug. The doctor may then provide this information to a system that performs real-time drug dosing recommendations. The system receives the information provided by the doctor, such as various patient information as well as information about the dosing schedule, such as the size of the dose, the frequency of doses, and how long the patient has been taking the drug, and PK or PD information for the patient with respect to the drug. The system accesses a non-linear mixed effects model (“NLME”) for the drug, drug records of other patients' PK or PD information, and uses the received patient information along with other patient data records and dosing schedule information to update the NLME. The system then estimates and updates the model parameters from the NLME and the patient information employing a Bayesian network to generate a recommended dosing regimen for the patient. The system then provides the recommended dosing regimen to the doctor, with the predicted exposures and/or responses for evaluation, who then prescribes a dosing regimen to the patient.

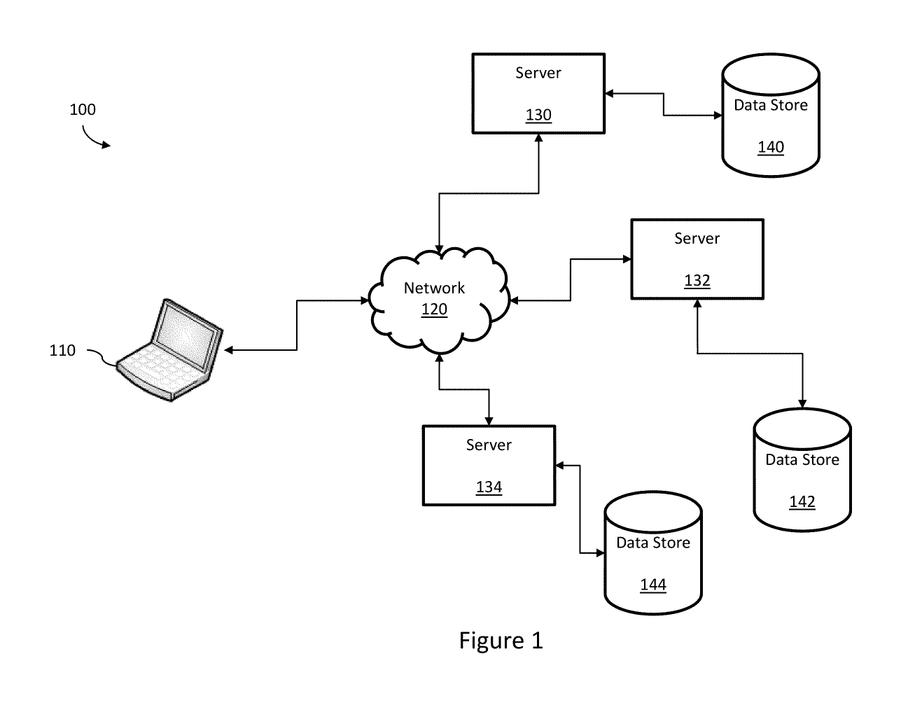

FIG. 1 shows an example environment 100 for providing personalized patient dosing regimens. The environment 100 includes a computing device 110, network 120, servers 130-134, and data stores 140-144. The computing device 110 can communicate through the network 120, which may be one or more networks, with these other devices. The computing device 110 can be a mobile device that can communicate over the network 120, such as a wireless communication network, with the other devices. The servers 130-134 may be database server devices that provide access to structured data in the data stores 140-144 to the computing device 110 through the network 120.

In some aspects, the environment 100 can be a distributed computing system where one or more applications can be executed concurrently to obtain one or more drug dosing regimen recommendations. One or more of the servers 130-134 can execute an application (or applications) to analyze data stored in one or more of the data stores 140-144 to obtain the drug dosing regimen recommendation(s). In some aspects, the environment 100 can be used by one or more applications to input patient data received from a data source, such as a healthcare provider, into one or more of the data stores 140-144 and, in response, determine a drug dosing regimen recommendation. In some aspects, the environment 100 can include management, prioritizing, and execution of certain instructions from the application(s).

In some aspects, the data stores 140-144 can store structured data sets of patient characteristics or profiles for one or more patients. For example, data store 140 may be configured to store structured data sets of patient characteristics based on an entire population of patients, a region in which patients reside, a specific hospital site, and a patient's healthcare provider. For example, data sets of patient health information may be structured such that patients in North America are segregated from patients that live in Asia. In some aspects, an entire patient population may be all of the patients in the world, a continent, a state or a city. Server 130 may segregate the patient health information based on the patient population, region of which patients reside, a specific hospital site of patients, or a patient's healthcare provider.

In some aspects, one of the servers 130-134 can be a database server that can receive and electronically respond to a query for drug dosing regimen information based on input patient characteristics. For example, one of the servers 130-134 can be a database server that receives patient characteristics and drug dosing regimen information for that particular patient. For example, one or more of the servers 130-134 can receive data regarding the patient's exposure and response to a particular drug. The server(s) 130-134 can also receive an evaluation of a patient's PK or PD information.

One or more of the servers 130-134 can be in communication with another server or servers 130-134. For example, one server 130 can transmit and receive queries to obtain a recommendation of drug dosing regimen information and input patient characteristics into a data store 140. The server 130 can also communicate received patient characteristics and drug dosing regimens of particular patients to the data store 140.

A server 130-134 can be a database that electronically stores recommended dosing regimen data for a specific patient. For example, a server 130 can receive recommended dosing regimen data for a specific patient. The server 130 can electronically store adjusted recommended dosing regimen data for a specific patient in a data store 140-144. The server 130 can also receive adjusted recommended dosing regimen data for a specific patient. The server 130 can also transmit recommended drug dosing regimen data and adjusted recommended drug dosing regimen data to the computing device 110 over the network 120.

The computing device 110 can receive data from one or more of the servers 130-134 via the network 120. As discussed above, the network 120 may be any suitable network, such as the Internet, a cloud-based network, an intranet, local area network, wireless local area network, wide area network, microwave network, satellite network, Integrated Services Digital Network, cellular network, and combinations of these or other types of networks.

The computing device 110 can execute one or more applications that permit querying and collecting drug dosing regimen data and that can obtain drug dosing regimen information or recommendations.

Although depicted separately, in some examples, the servers 130-134 may include the one or more of the data stores 140-144. In some aspects, the computing device 110 itself may include or be in communication with one or more of the data stores 140-144. In some aspects, the environment 100 does not include one or more of the server 130-134 or the network 120. For example, the computing device 110 may directly communicate with one or more of the data stores 140-144. In other aspects, one or more of the servers 130-134 may include a computing device 110.

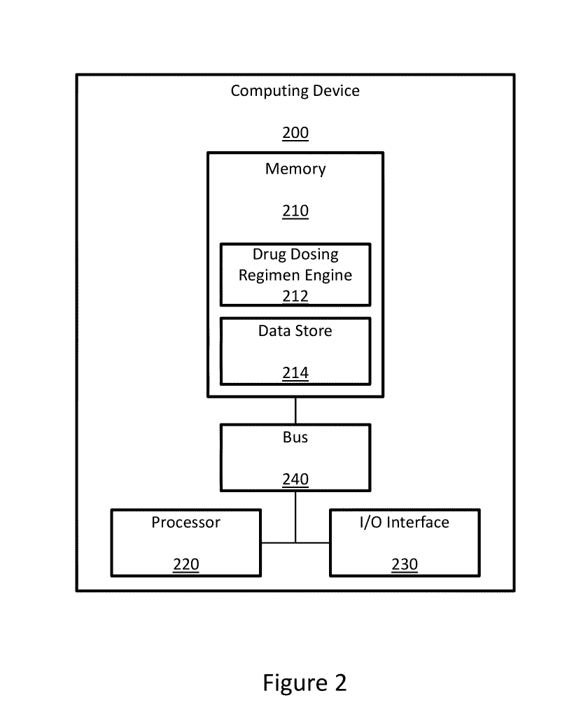

FIG. 2 shows an example computing device 200 for providing personalized patient dosing regimens. Other suitable examples may of course be used. The computing device 200 includes a processor 220, a memory 210, an input/output (I/O) interface 230, and a bus 240. The memory 210 includes a tangible computer-readable memory on which program code is stored. A processor 220 can execute program code stored in the memory 210 by communicating via the bus 240 to cause the computing device 200 to perform one or more actions. The computing device 200 can include an input/output (I/O) interface 230 for communication with other components, such as the network 120 and servers 130-134 of FIG. 1. The computing device 200 may be any device that can electronically process data and execute code that is a set of instructions to perform actions. Examples of the computing device 200 include a database server, server cluster, cloud server, web server, desktop personal computer, laptop personal computer, handheld computing device, and mobile device.

In some aspects, the input/output (I/O) interface 230 can be a transceiver for wireless communications. Examples of wireless communication provide for communication over a cellular network, Wi-Fi network, wireless local area network, and the like. In some aspects, the input/output (I/O) interface 230 can remotely communicate with one or more of the servers 130-134 or one or more of the data stores 140-144.

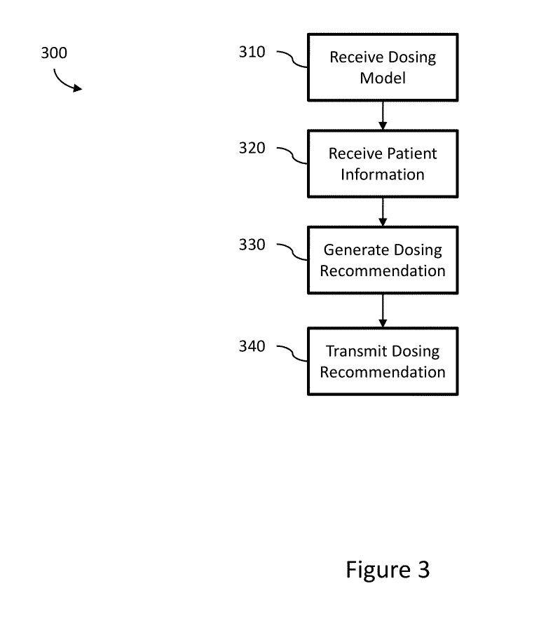

Referring now to FIG. 3, FIG. 3 shows an example method 300 for providing personalized patient regimens. The example method 300 of FIG. 3 will be discussed with respect to the environment 100 of FIG. 1. However, other suitable devices or environments are appropriate for use with this example method 300. For example, in some aspects, the computing device 200 of FIG. 2 may be configured to perform one or more of the steps of the method 300. The method 300 begins at block 310.

At block 310, the computing device 110 or a server 130-134 receives a dosing model. For example, one or more of the servers 130-134 may access a data store 140-144 to access or obtain one or more dosing models for corresponding drugs. In one example, server 130 accesses data store 140, which stores dosing models for a plurality of drugs, and issues a database query to the data store 140 to access a dosing model. In some examples, the server 130 stores one or more dosing models in a computer-readable medium local to the server, such as in a hard drive or in RAM. In some examples, the server 130 accesses a dosing model that includes one or more of a NLME model or a Bayesian model. In various aspects, dosing models may comprise one or more suitable NLME, Bayesian, PK, or PD models.

In some examples, the computing device 110 may receive the dosing model. For example, the computing device 110 may transmit a request to one or more of the servers 130-134 for a dosing model, and in response, a server 130-134 may transmit the requested dosing model to the computing device 110. In some examples, the computing device 110 may access a dosing model via a web page and thus may receive access to the dosing model, though it may not actually receive the dosing model data structure or program code itself.

After the dosing model has been received, the method 300 proceeds to block 320.

At block 320, the computing device 110 or a server 130-134 receives patient information. The patient information can include various kinds of information, such as age, height, weight, medical history, demographics, medical conditions, other drugs the patient is taking, and other patient information. In one example, the computing device 110 may display a graphical user interface (“GUI”) configured to request or obtain patient information.

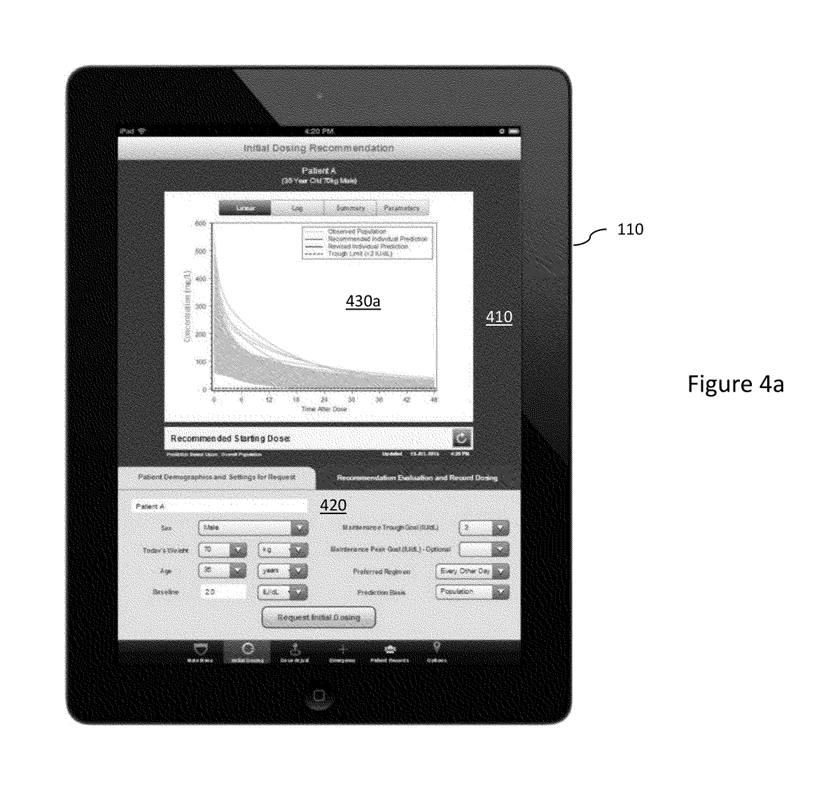

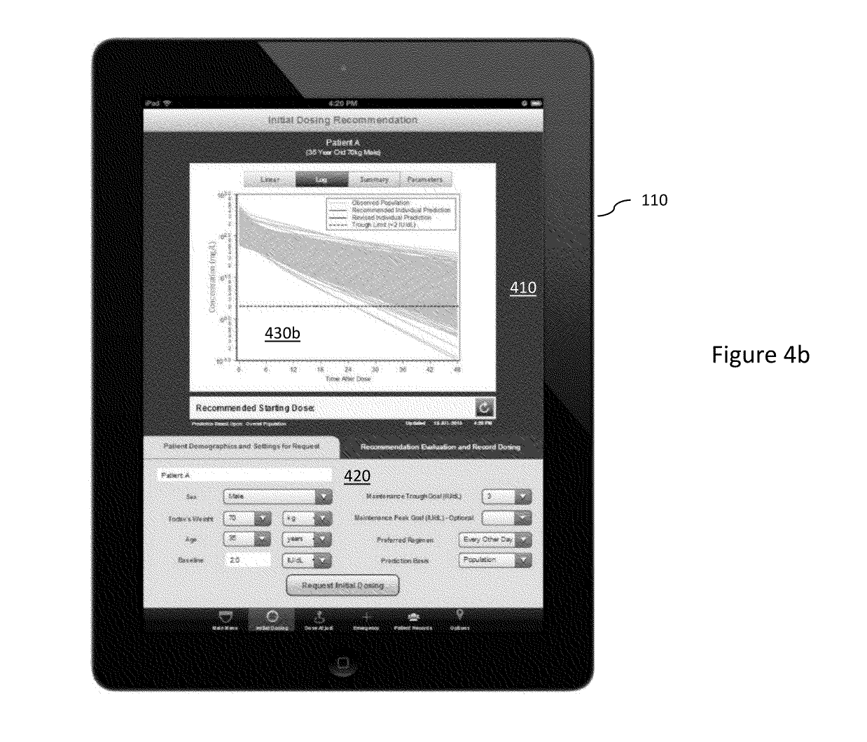

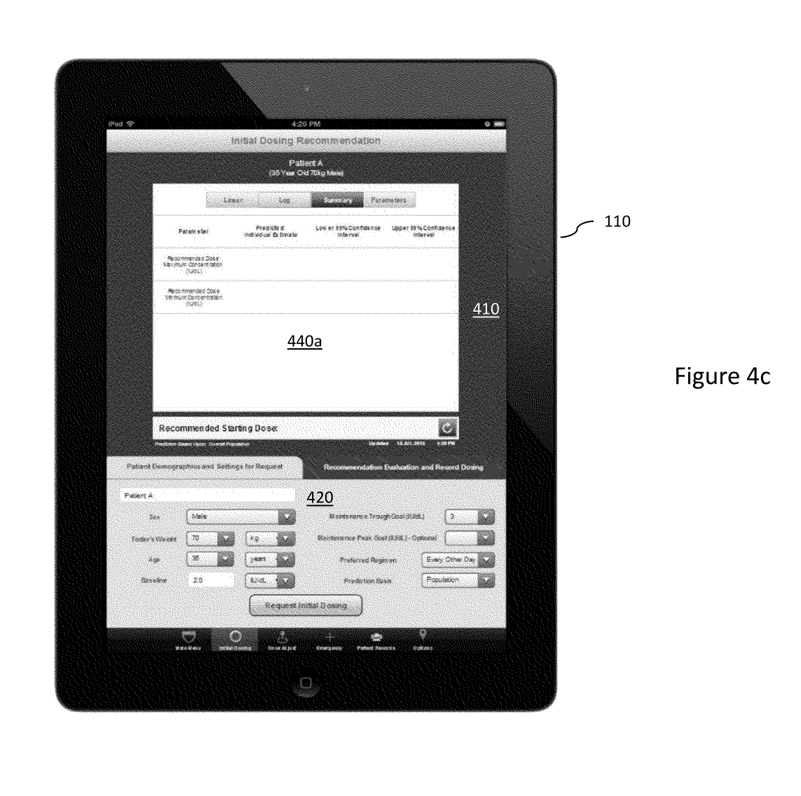

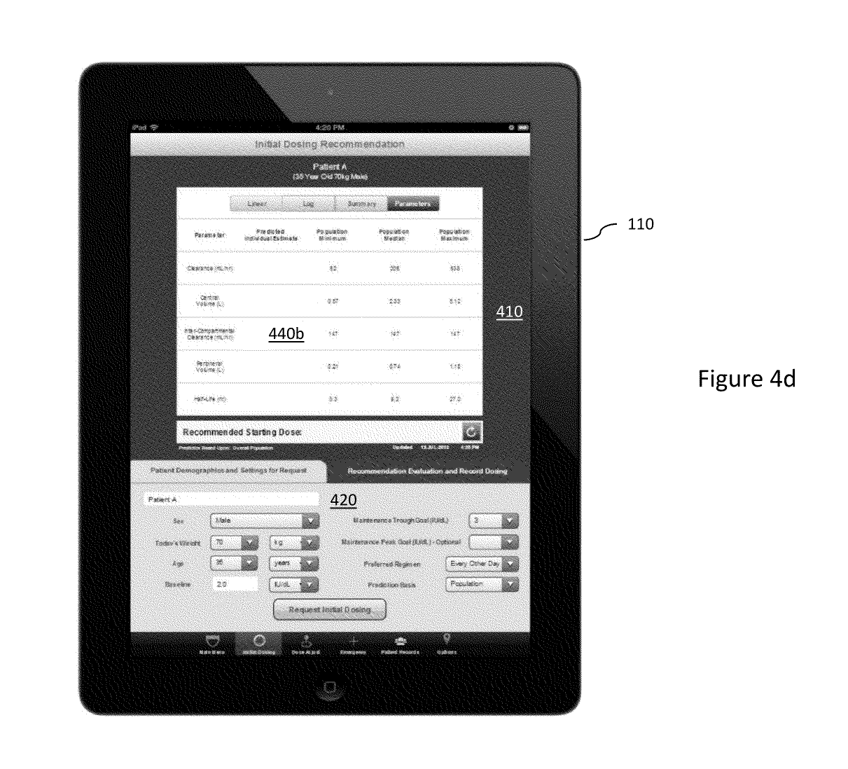

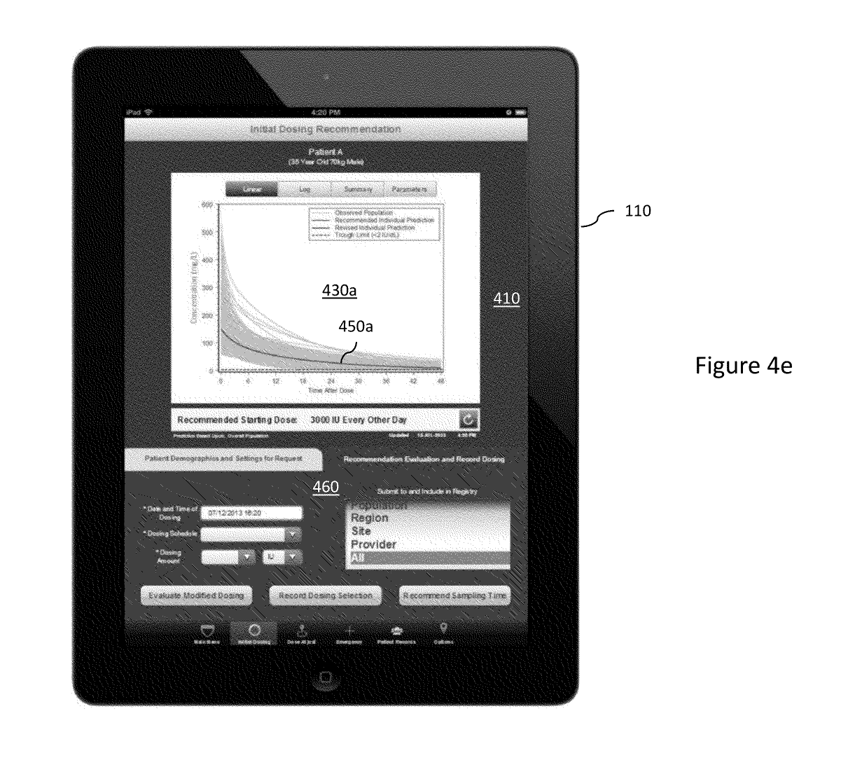

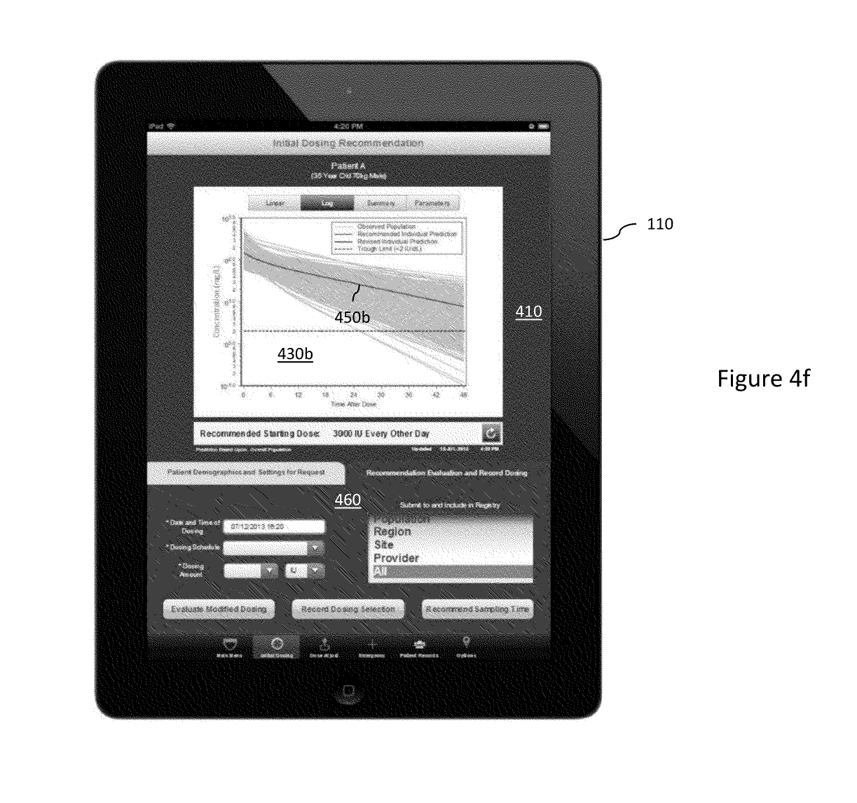

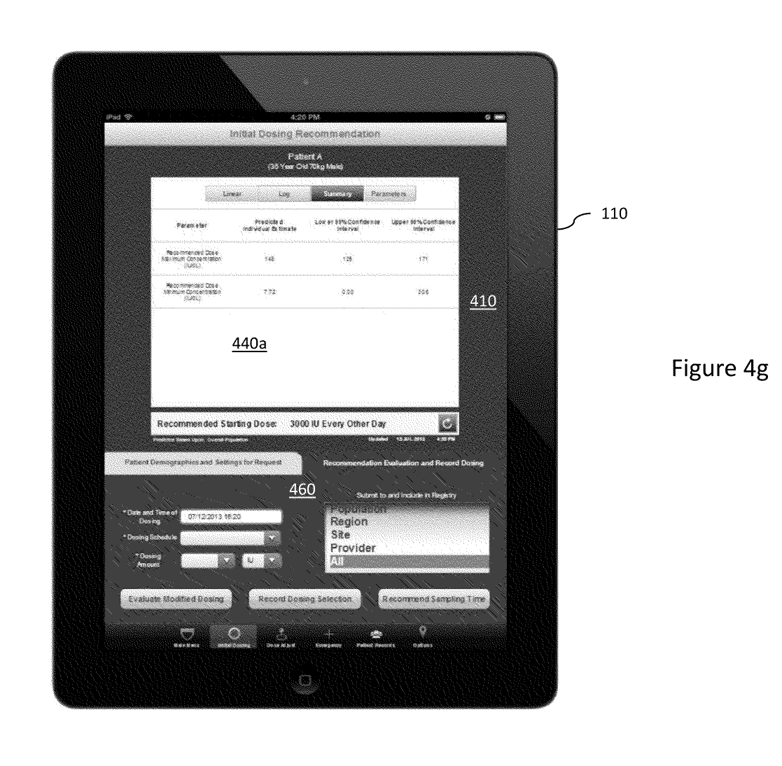

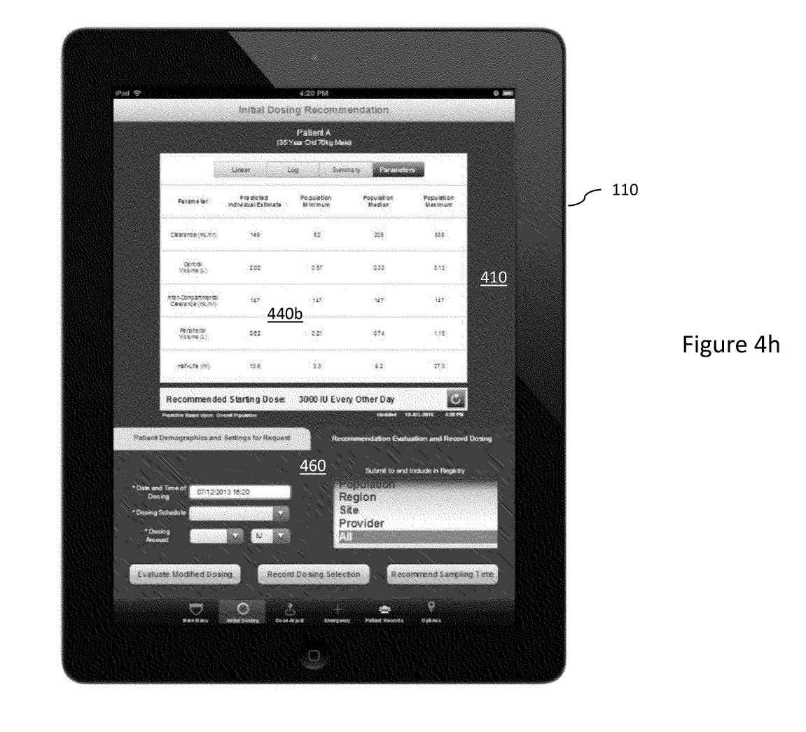

Referring to FIG. 4a, FIG. 4a shows an example GUI 410 that includes user interface elements that can receive patient information. In the example shown in FIG. 4a, the GUI includes an area 420 having interface elements that can receive a patient name, “Patient A” in this example, the patient's sex, the patient's current weight, the patient's age, a base concentration of a substance in the patient's blood, a goal maintenance trough concentration level of the substance in the patient's blood, a maintenance peak goal concentration level, a preferred regimen, and a basis on which to make the prediction. However, in some examples, various patient information may be obtained, including more, fewer, or different characteristics than those shown in FIG. 4a.

As discussed above, the GUI 410 shown in FIG. 4a enables a user to enter patient characteristics for requesting an initial dosing recommendation. FIG. 4a also includes graphical information 430 indicating PK or PD information for the drug in a population. In this aspect, the FIG. 4a illustrates linear graphs of concentrations of a substance in a population's patients' blood over time.

FIGS. 4b-d show other aspects of the GUI 410 shown in FIG. 4a. FIG. 4b shows an aspect of the example GUI 410 of FIG. 4a where the user has selected a view of the graph of concentration of a substance in a patient's blood over time using a logarithmic scale instead of the linear scale shown in FIG. 4a. FIG. 4c shows an aspect of the example GUI 410 of FIG. 4a where summary numerical information 440a may be presented to the user, such as for comparison purposes. FIG. 4d shows an aspect of the example GUI 410 of FIG. 4a where numerical parameter information 440b related to a patient population is provided. For example, numerical parameter information 440b in this example is shown related to population minima, medians, and maxima for various parameters, such as clearance (in milliliters (ml) per hour (hr)) of a substance, a central volume, an inter-compartmental clearance, a peripheral volume, and a half-life. In some embodiments other parameters may be shown, or different statistical information may be provided, such as standard deviations, means, variances, etc.

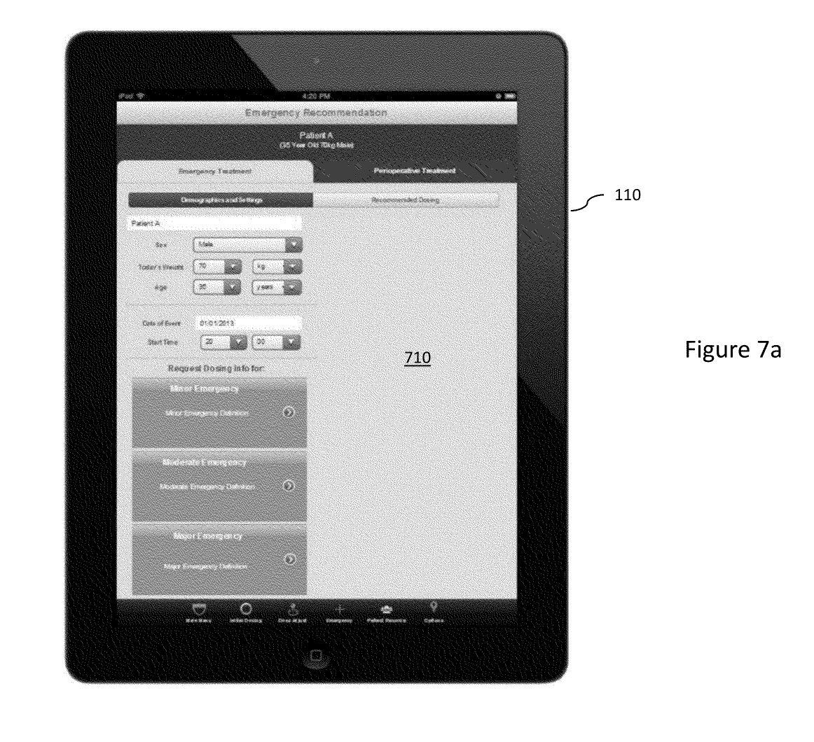

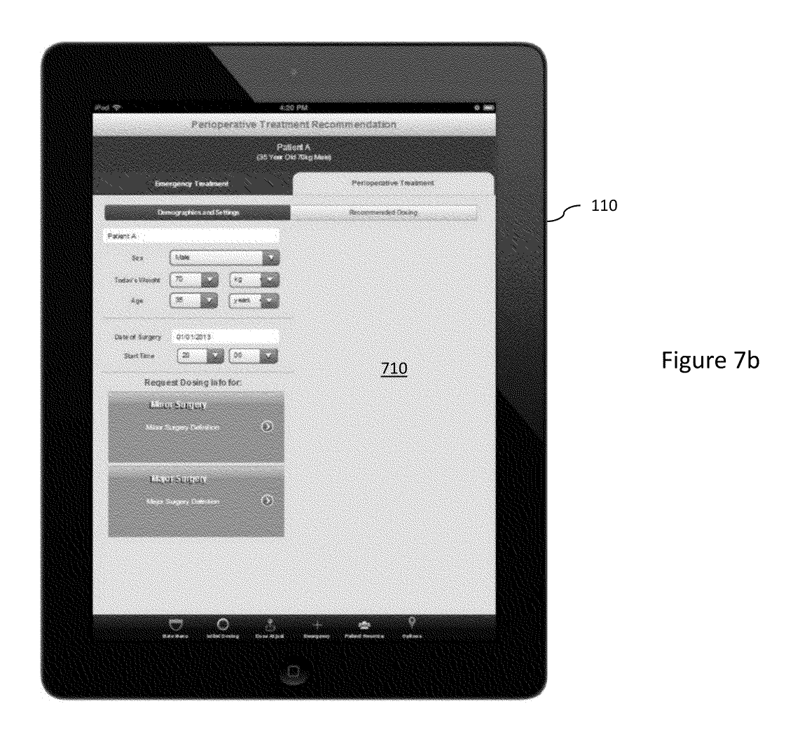

Referring now to FIG. 7a, FIG. 7a illustrates another example of a GUI 710 for requesting a dosing recommendation, either for an initial dosing recommendation or an updated dosing recommendation. In this example, the recommendation is for an emergency dosing regimen recommendation for a patient. As may be seen, the GUI 710 provides interface elements to allow entry of patient characteristics, such as a patient name, sex, weight, and age. It also includes interface elements to enable a user to enter information related to an emergency event. The GUI 710 enables the user to enter the date and time of the emergency event, and to select the severity of the emergency, ranging from a minor emergency to a major emergency. In some examples, when such an emergency recommendation is received by a server 130-134, the server 130-134 may prioritize the dosing recommendation above other received requests for dosing recommendations or updates to be performed for a dosing model to provide a quick response to the emergency dosing recommendation request.

Referring now to FIG. 7b, FIG. 7b illustrates another aspect of a GUI 710 for requesting a dosing recommendation. In this aspect, the recommendation is for a surgical procedure dosing recommendation for a patient. As may be seen, in this aspect the GUI 710 provides interface elements to allow entry of patient characteristics, such as a patient name, sex, weight, and age. It also includes interface elements to enable a user to enter information related to a scheduled surgery. The GUI 710 enables the user to enter the date and time of the scheduled surgery, and to select the severity of the surgery, ranging from a minor surgery to a major surgery. In some examples, when such a recommendation related to an upcoming surgery is received by a server 130-134, the server 130-134 may prioritize the dosing recommendation above other received requests for dosing recommendations or updates to be performed for a dosing model to provide a quick response to the dosing recommendation request, or it may prioritize the recommendation to be completed within a predetermined period of time prior to the scheduled surgery, such as 24 hours in advance.

After receiving the patient information, the computing device 110 may provide the patient information to one or more of the servers 130-134, which receive the patient information from the computing device 110.

In some examples, the computing device 110 or a server 130-134 receives patient information from a data store or from a remote data source. In one example, the computing device 110 may receive identification information about a patient, such as a name, a social security number, a driver's license number, a passport number, or other identifier for the patient.

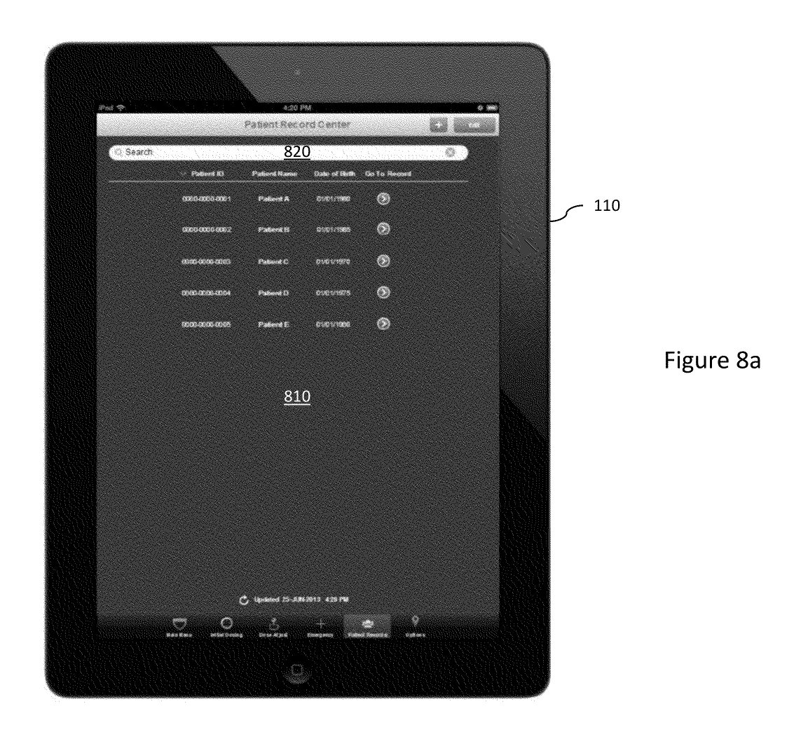

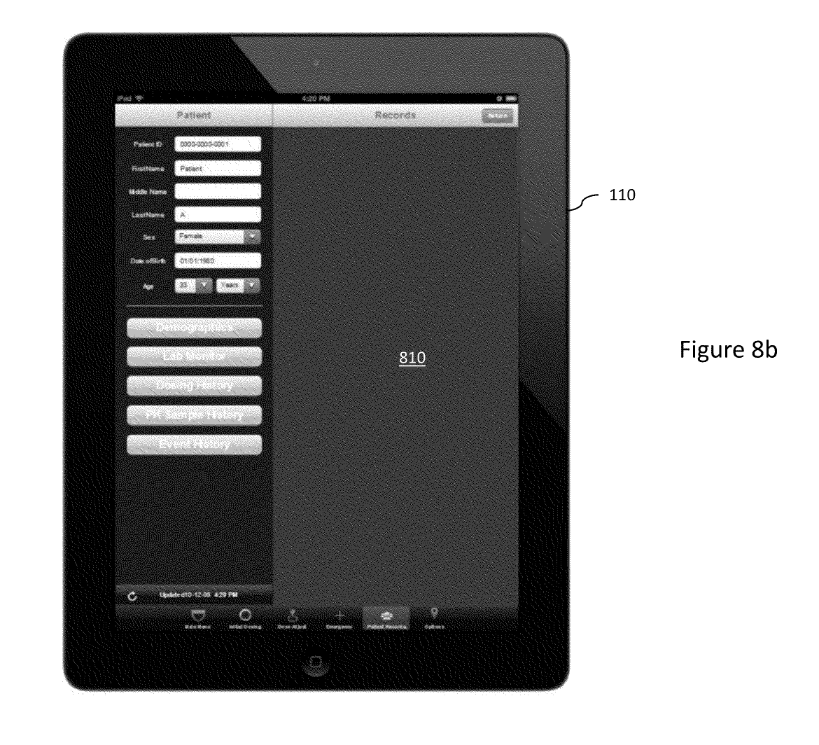

For example, referring to FIG. 8a, FIG. 8a shows an example GUI 810 for a software application that allows a user to search for patient records. In this example, the user may enter one or more search parameters in a search area 820. After a search parameter, or parameters, is entered, the computing device 110 performs a search for patient records associated with the search parameter(s). In one example, the computing device 110 may transmit a query to one or more database servers, such as servers 130-134, based on the search parameter(s). The computing device 110 or a server 130-134 may then obtain one or more medical records, such as electronic medical records (EMRs), associated with the patient using the identification information. For example, as may be seen in FIG. 8a, five patient records have been identified as being associated with an entered search parameter. The user may then select one or more of the patient records. One or more EMRs may also be provided to the computing device 110 in response to the search.

After receiving an EMR, the computing device 110 or a server 130-134 may extract patient information. In one example, an EMR may include laboratory test results or information about various compound concentrations in a patient's blood sample, such as PK or PD information. In some examples, an EMR may include patient health information, such as medication information or allergy information.

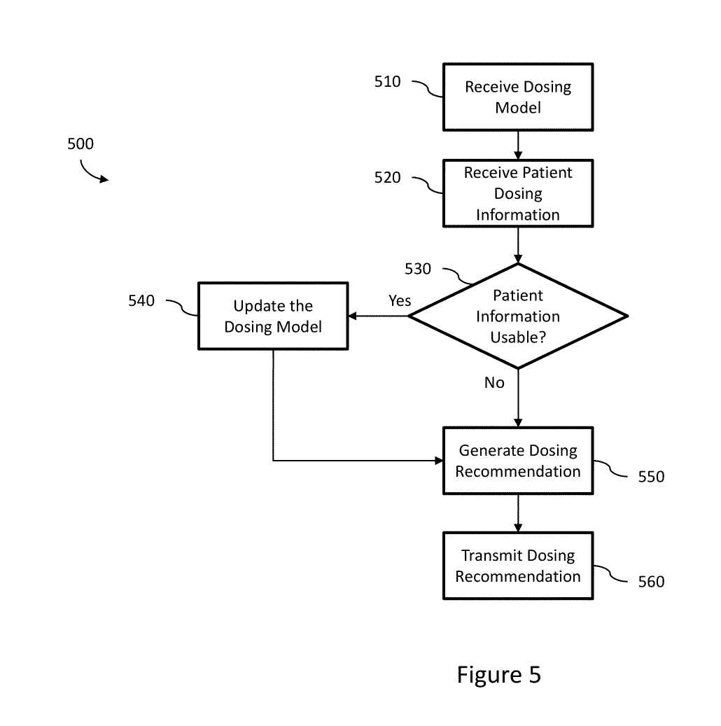

For example, FIG. 8b shows an aspect of the GUI 810 in which a user may view a selected patient's record. In this example, the record includes a patient ID, a patient's first name, middle name, last name, sex, date of birth, and age in years. In addition, other information associated with the patient may be accessed by selecting one or more buttons, including demographic information, lab monitor information, dosing history information, PK sample history, or event history. After selecting a patient based on the search parameters, the computing device 110 may employ the information to request an initial dosing recommendation (or an updated dosing recommendation as described with respect to FIG. 5 below).

After the computing device 110 or a server 130-134 receives the patient information, the method 300 proceeds to block 330.

At block 330, a server 130-134 generates a dosing recommendation. In one example, server 130 has received patient information from the computing device 110 a request for a dosing recommendation for the patient for a particular drug. To obtain a dosing recommendation, the server 130 accesses the dosing model that was previously obtained, or, in some examples, obtains the dosing model in response to receiving the request for the dosing recommendation. In some examples, to generate the dosing recommendation, the server 130 accesses the dosing model, which in this example includes a NLME model, and a wide dynamic Bayesian network. In this example, the system employs the NLME model to obtain parameters for the drug. Parameters from the NLME model are then provided to the wide dynamic Bayesian network. In addition, one or more patient characteristics from the received patient information are provided to the wide dynamic Bayesian network. For example, as discussed above with respect to FIG. 4a, patient characteristics may include the patient's sex, the patient's current weight, the patient's age, a base concentration of a drug in the patient's blood, a goal maintenance trough concentration level of the drug in the patient's blood, a maintenance peak goal concentration level, and a preferred regimen. The server 130 then employs the wide dynamic Bayesian network to obtain an initial dosing recommendation for the patient.

In some examples, the server 130 may select a dosing model that is based on the patient characteristics. For example, a data store 140 may include multiple different dosing models, such as NLME models, Bayesian models, or PK or PD models, for a drug that represent different patient populations. For example, the data store 140 may include dosing models for a drug based on patient populations in the US, in one or more foreign countries, in a region of the US, for different US populations based on age (e.g., one model for patients between ages 16 and 45 and a second model for patients over age 45), or based on other characteristics. In one such example, the server 130 may obtain the most appropriate dosing model from the data store 140 based on one or more received patient characteristics, employ the dosing model to obtain parameters for the Bayesian network, and then employ the Bayesian network to obtain an initial dosing recommendation for the patient. After obtaining an initial dosing recommendation for the patient, the method 300 proceeds to block 340.

At block 340, the server 130 transmits the initial dosing recommendation to the computing device 110. In the example environment 100 shown in FIG. 1, the server 130 transmits the initial dosing recommendation to the computing device 110 via the network 120. In some examples, the computing device 110 itself may generate the initial dosing recommendation and may transmit the recommendation to a user interface or to a software application that requested the initial dose recommendation.

After receiving the initial dosing recommendation, the computing device 110 may provide the initial dosing recommendation to a user. For example, the computing device 110 may execute a software application for requesting and obtaining dosing information for one or more drugs for a patient as described above.

Referring now to FIG. 4e, FIG. 4e shows an aspect of GUI 410. In this aspect, the computing device 110 has received an initial dosing recommendation from a server 130 and has provided the initial dosing recommendation to the GUI 410 shown in FIG. 4e. In this example, the GUI 410 provides a “Recommended Starting Dose” of “3000 IU Every Other Day.” In some examples, an initial dosing recommendation may include one or more of a dose amount, a dosing interval, or an exposure level. In addition, as discussed above with respect to FIG. 4a, the GUI 410 includes a graph 430a showing a linear graph of concentration of a substance in a patient's blood over time. In addition, the computing device 110 provides an additional illustration of an expected PK or PD response 450a of a patient to the initial dose recommendation. In this aspect, the computing device 110 has received estimated PK or PD response information for the patent from the server 130, though in some aspects the computing device 110 may calculate the estimated PK or PD response information for the patient. The GUI in FIG. 4e illustrates the estimated PK or PD response 450a as a darker line visible within the graph 430a of the observed PK or PD response for the relevant population. Thus, by examining the GUI 410, a user may be able to determine whether the expected PK or PD response for the patient appears to be appropriate for the relevant population, or if the expected PK or PD response for the patient appears to be outside of a desirable range for the relevant population.

FIG. 4f shows another aspect of the GUI 410 in which the recommended dose of 3000 international units (“IU”) every other day is provided. In this example, the user has selected an option to view the graph 430b on a logarithmic scale. As with the aspect shown in FIG. 4e, the computing device 110 provides an additional illustration of an expected PK or PD response 450b of a patient to the initial dose recommendation. In this aspect, however, the patient's expected PK or PD response 450b is shown on a logarithmic scale.

FIG. 4g shows another aspect of the GUI 410 that includes summary numerical information 440a presented to the user, such as for comparison purposes. In this aspect, the predicted initial estimates fall within the lower and upper 99% confidence intervals.

FIG. 4h shows an aspect of the example GUI 410 where numerical parameter information 440b related to a patient population is provided. In this example, the patient's predicted individual estimates fall within the population minima and maxima as may be seen.

Referring again to FIG. 3, after transmitting the initial dosing recommendation, the method 300 concludes, though in some embodiments, it may repeat for additional requests, or may be executed concurrently by a plurality of different servers 130-134 or computing devices 110.

Referring now to FIG. 5, FIG. 5 shows an example method 500 for personalized patient dosing regimens. The example method 500 of FIG. 5 will be discussed with respect to the environment 100 of FIG. 1. However, other suitable devices or environments are appropriate for use with this example method 500. For example, in some aspects, the computing device 200 of FIG. 2 may be configured to perform one or more of the steps of the method 500. The method 500 begins at block 510.

At block 510, the computing device 110 or a server 130-134 receives a dosing model as described above with respect to block 310 of FIG. 3. After receiving the dosing model, the method 500 proceeds to block 520.

At block 520, the computing device 110 or a server 130-134 receives patient dosing information. For example, after a patient has been following a dosing regimen based on an initial dosing recommendation for a period of time, the patient may undergo a blood test to determine PK or PD information, such as concentrations of a drug or other substance in the patient's blood resulting from the initial dosing recommendation. The doctor may then provide the patient's PK or PD information to the server 130, such as by entering the information into a software application executing on the computing device 110, or by accessing a web page configured to provide information to the server 130. In some examples, dosing information may include patient information, a dosing regimen, a drug, a dosing history over the course of the regimen, missed doses, extra doses, incorrect doses, or PK or PD information. However, in some examples, different types or quantities of dosing information may be provided.

In one example, the computing device 110 executes an application that can receive drug dosing regimens and patient characteristics. For example, the computing device 110 can receive a listing of a particular patient's characteristics, the drug taken by the patient, the drug dosing regimen taken by the patient, and data about the effect (e.g., PK or PD effect) based on the regimen.

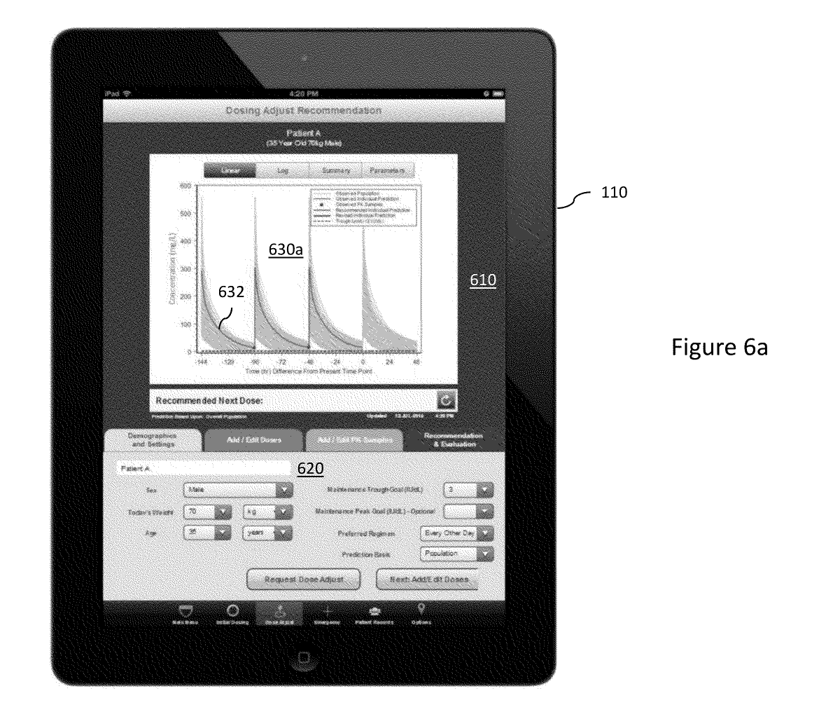

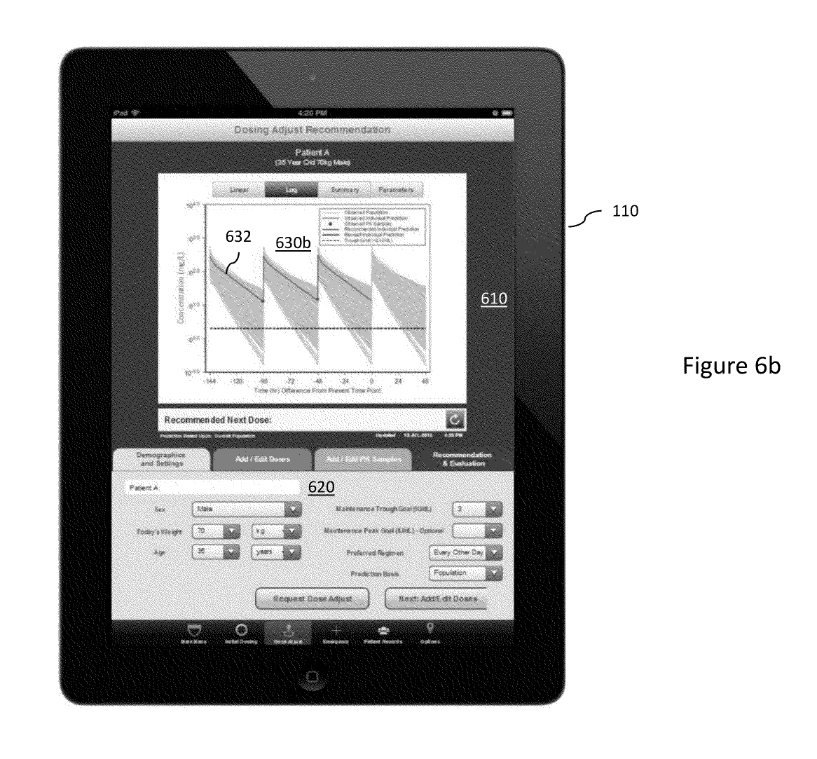

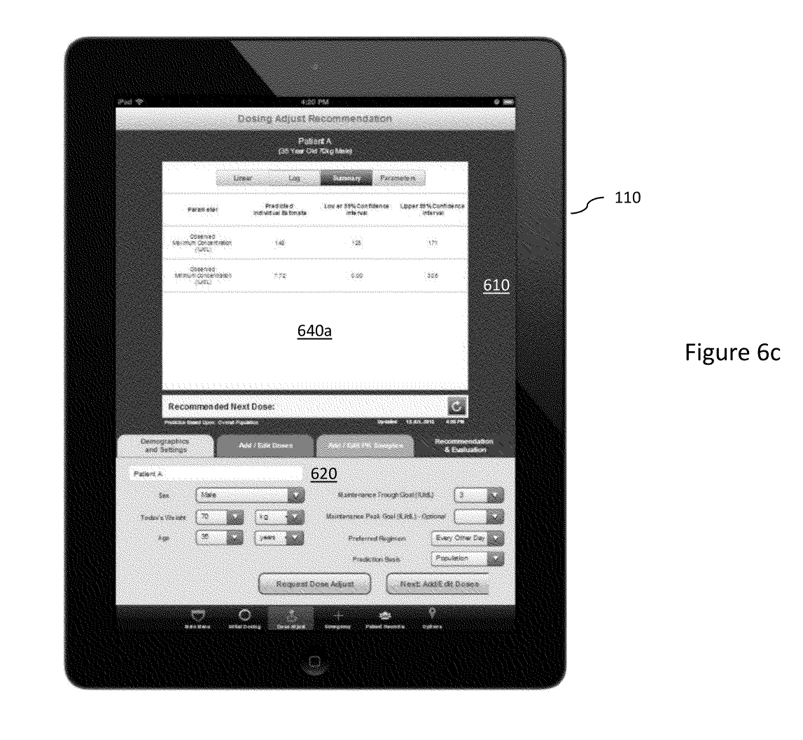

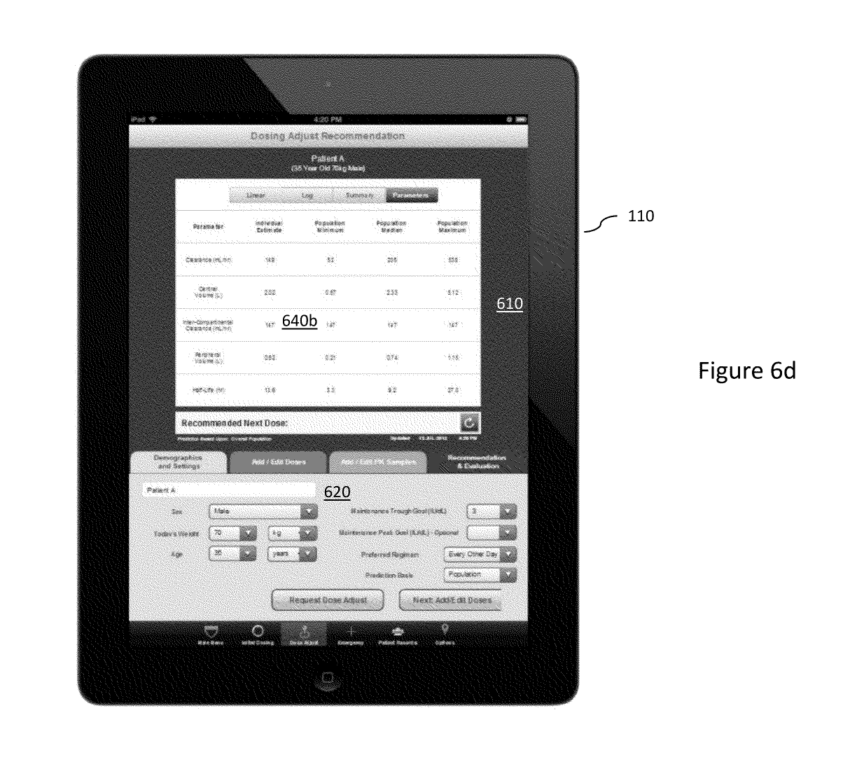

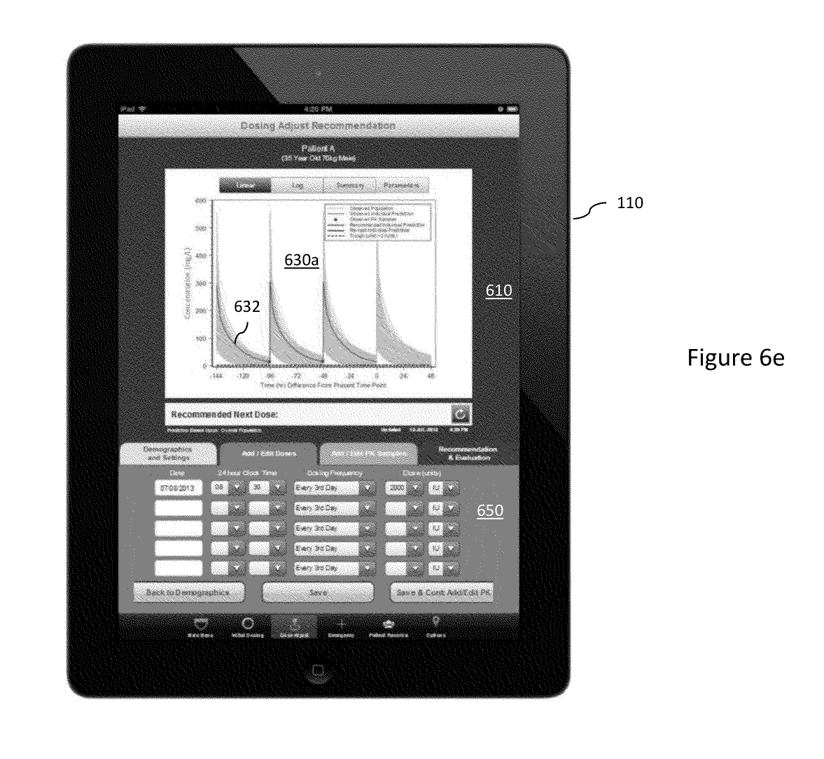

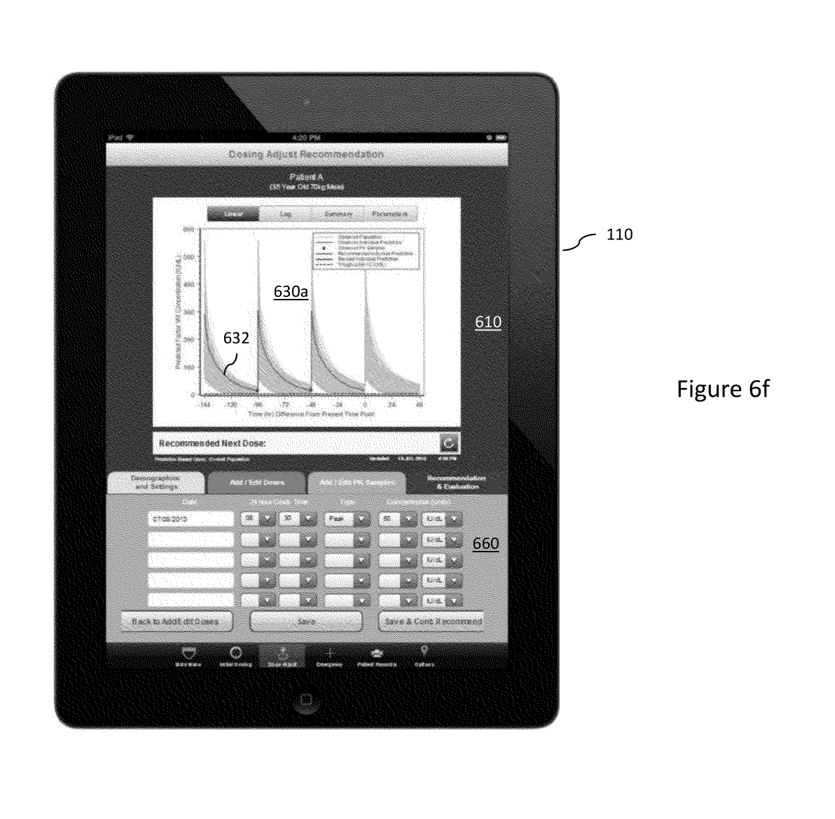

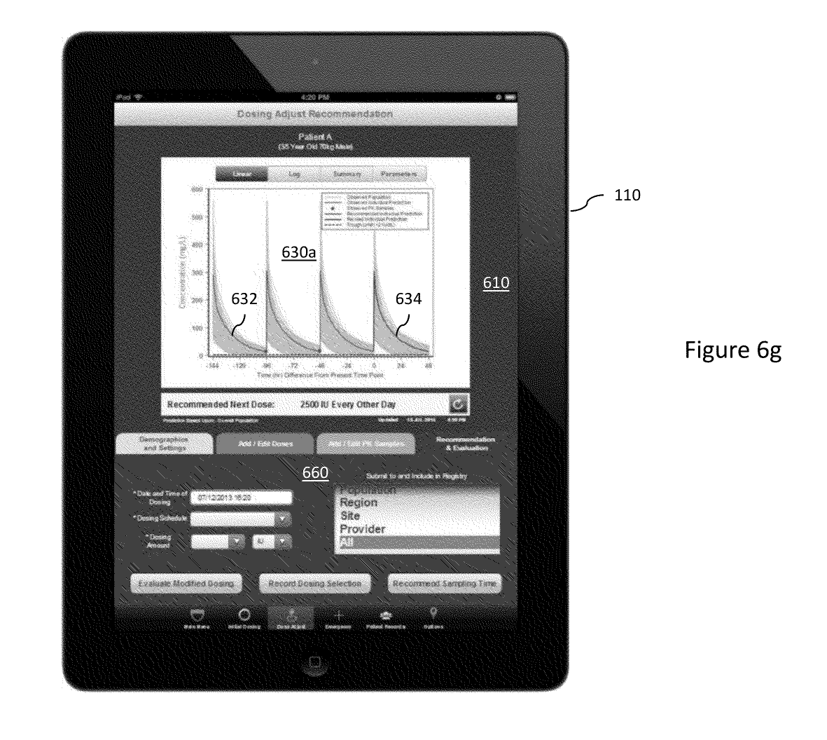

Referring now to FIG. 6a, FIG. 6a illustrates a computing device 110 executing a software application for requesting a dosing adjustment recommendation (or an updated dosing recommendation). In this example, the software application provides a GUI 610 for a user to interact with to provide information and view information. The GUI 610 of FIG. 6a includes user interface elements 620 that enable a user to enter patient information. As may be seen in FIG. 6a, in this example the user may enter a patient's name, sex, weight, age, a maintenance trough goal, a maintenance peak goal, a preferred regimen, and a prediction basis. In addition, the GUI 610 provides a graphical view 630a of a populations' PK or PD response to a drug and a darker line 632 representing the patient's own PK or PD prediction. In this example, the respective multiple dose graphs are shown in a linear scale.

FIGS. 6b-d show other aspects of the GUI 610 shown in FIG. 6a. FIG. 6b shows an aspect of the GUI 610 of FIG. 6a, however in this aspect, the user has elected to view a graph 630b of the populations PK or PD values and the patient's predicted PK or PD values in a logarithmic scale. FIG. 6c shows an aspect of the GUI 610 in which the user is presented with summary information 640a about the patient's predicted PK or PD information in conjunction with PK or PD data from the relevant population. FIG. 6d illustrates an aspect of the GUI 610 with parametric information 640b in which the patient's predicted PK or PD parameters are provided in conjunction with statistical values for the respective parameters from the population, including minimum, median, and maximum values. In some embodiments, other statistical information may be provided, such as standard deviations, means, variances, etc.

Referring now to FIG. 6e, FIG. 6e shows another aspect of the GUI 610 shown in FIG. 6a. In this aspect, a user has selected an option to interact with dosing interface elements 650 to provide information about doses of a drug taken by the patient, whose characteristics were entered using the interface elements 620 shown in FIGS. 6a-d. In this example, the user has entered information about a dose taken on Jul. 8, 2013 at 8:30 am of 2000 IU of the drug. The interface elements 650 also indicate that the dosing regimen is for a dose to be taken every 3 days. Using such an example, a user may enter information about multiple doses, including the dates and times of the doses, as well as the amount of the drug taken at each dose.

Referring now to FIG. 6f, FIG. 6f shows an aspect of the GUI 610 in which a user has selected an option to access PK sample interface elements 660. Using these interface elements 660, the user is able to enter PK information for the patient. In this case, the user entered PK information based on a test sample taken on Jul. 8, 2013 at 8:30 am. The entered PK information is the peak concentration and indicates a concentration level of 60 IU/deciliter (“dL”). Using such interface elements 660, the user may enter one or more PK test results that may be transmitted to the server 130 to obtain an updated dosing recommendation.

After the server 130 receives the patient dosing information, the server 130 stores the patient dosing information in a data store 140-144. For example, data store 140 stores data records associated with a clinical trial for the drug or associated with other patient dosing information, such as PK or PD information, for the drug, and adds one or more new data records based on the received patient dosing information. In one example, the server 130 receives patient dosing information from one or more sources, such as a drug company, one or more providers, one or more clinical research organizations, or other sources of patient dosing information. The received patient dosing information may then be added to the pool of data related to the PK or PD information about the drug. In some examples, the received patient dosing information may be stored in multiple data stores 140-144. For example, a first data store 140 may store patient dosing information associated with patients from the US, a second data store 142 may store patient dosing information associated with patients from the southeastern US, and a third data store 144 may patient dosing information associated with patients from a provider. When patient dosing information is received by the server 130, the server 130 may store the patient dosing information in one or more of the data stores 140-144 based on the patient dosing information satisfying population criteria associated with the respective data store. In some examples, patient dosing information may not be stored.

After the server 130 has received the patient dosing information, the method 500 proceeds to block 530.

At block 530, the server 130 determines whether the patient dosing information may be used to update a dosing model. In one example, a dosing model is restricted to the use of data from patients located within the United States (“US”). Such a requirement may be imposed by one or more regulatory agencies, such as the Food and Drug Administration (“FDA”). In this example, the dosing model may be periodically updated using data from one or more data stores 140-144; however, only patient data associated with patients located within the US may be used. In some examples, a dosing model may be eligible to use data from any patient and thus the server 130 may use any available patient information. In some examples, a dosing model may be developed or maintained by a particular provider, such as a hospital, within a particular region, such as the southeastern US, or by a particular governmental entity, such as the FDA, the National Institutes of Health (“NIH”), or the Centers for Disease Control (“CDC”). In some such examples, the respective provider, region, or entity, may establish parameters governing which patient data may be used. In such examples, the server 130 may access data in one or more data stores 140-144 based on such parameters to obtain suitable data.

To determine whether the received patient dosing information may be used to update a dosing model, the server 130 analyzes the dosing model to determine one or more parameters associated with the dosing model that identify patient characteristics required for data to be used to update the dosing model. In one example, the dosing model has associated parameters indicating a nationality, a patient location, an age, a sex, a provider, or other characteristic. After identifying the one or more parameters, the server 130 analyzes the received patient dosing information to determine whether the patient dosing information satisfies the one or more parameters. In some examples, if the received patient dosing information satisfies at least one of the parameters, the patient dosing information is suitable for use to update the dosing model. In some examples, if the received patient dosing information satisfies all of the parameters, the patient dosing information is suitable for use to update the dosing model. Or in some examples, the server 130 does not identify any parameters associated with the model that identify patient characteristics required for data to be used to update the dosing model. In one such example, all received patient dosing information is suitable for use to update the dosing model. Further, it should be noted that the step of determining whether the received patient dosing information is suitable for updating a dosing model need not be performed. For example, the server 130 may always update a dosing model with received patient information without making any determination as to the suitability of the patient dosing information.

If the patient dosing information is suitable for use to update the dosing model, the method proceeds to block 540. Otherwise, the method proceeds to block 550.

At block 540, the server 130 updates the dosing model. In some examples, a NLME or Bayesian model is updated based one or more patient records stored in one or more data stores 140. In one example, the server 130 transmits one or more queries to the data store(s) 140-144 to retrieve data records associated with patient dosing information stored in the data stores 140-144 based on the parameters identified at block 530. In some examples, the server 130 may transmit one or more queries to the data store(s) 140-144 to retrieve data records for patients with particular characteristics, such as described above. But in some examples, the server 130 may transmit one or more queries to the data store(s) 140-144 to retrieve all available data records associated with patients within the data store(s) 140-144 for a particular drug. In addition, or alternatively, one or more of the queries may also include other parameters, such as parameters indicating a start date or an end date for available data. For example, the server 130 may update a dosing model based only on available data obtained within the last 5 years.

After receiving the data records, the server 130 obtains population PK or PD information from the data records and generates a dosing model based on the population PK or PD information. In this example, the server 130 updates the dosing model by replacing the prior dosing model with the newly-generated NLME model based on the retrieved population PK or PD information. In some examples, the server 130 may update the existing dosing model using the retrieved population PK or PD information. Further, and as discussed above, suitable dosing models may be types of models other than NLME models, including Bayesian, PK, or PD models. After updating the dosing model at block 540, the method 500 proceeds to block 550.

At block 550, the server 130 generates a dosing recommendation for the patient whose dosing information was provided. Thus, the server 130 may provide updated dosing information for the patient. In this example, the server 130 uses the dosing model that was updated at block 540, if it was updated; otherwise, it employs the dosing model received at block 510. To generate the dosing information, with either the previously received dosing model or the updated dosing model, the system 130 performs the functionality described above with respect to block 330 of the method 300 shown in FIG. 3. After generating the dosing recommendation, the method 500 proceeds to block 560.

At block 560, the system 130 transmits the recommended dosing information as described above with respect to block 340 of the method 300 of FIG. 3.

Referring now to FIG. 6g, the computing device 110 displays the GUI 610 described above with respect to FIGS. 6a-f, however, in this aspect, the GUI 610 shows a dosing recommendation. As may be seen, a “Recommended Next Dose” of 2500 IU every other day has been provided. In addition, the graph information 630a illustrates the patient's predicted PK or PD response to the newly-recommended dose. Thus, the user is able to quickly obtain an updated dosing regimen for a patient based on the dosing information provided to the server 130 from the software application executed by the computing device 110.

After completing the transmitting at block 560, the method 500 completes.

The method 500 of FIG. 5 described above may be performed substantially in real-time, or near-real-time, to provide a patient with an updated dosing recommendation based on a dosing model that has been updated using the patient's dosing information. For example, the patient's doctor may provide the patient's dosing information to the server 130 and within a short period of time, may receive an updated dosing recommendation based on a dosing model that was updated to incorporate the dosing information sent by the doctor.

In some examples, the method 500 may delay the updating step at block 540 and provide an updated dosing recommendation without updating the dosing model, even if the received patient dosing information is suitable for use to update the dosing model. For example, it may be desirable in some examples to only update the dosing model periodically, such as every week or ever month, or only after a predetermined threshold amount of new dosing information is received, such as after 100 new patient dosing information records are received. Using different examples of the method 500 of FIG. 5 may provide an up-to-date dosing model based on real-world use of a drug and the associated PK or PD information. Thus, rather than using dosing models created using a limited patient population during a clinical trial, an organically-updated dosing model may provide better performance as greater quantities of dosing information is incorporated into the dosing model.

While the methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICS), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

That which is claimed is:

1. A method comprising:
receiving, from a non-transitory computer-readable medium, a dosing model for a substance;
receiving, from a remote device via a communications network, dosing information for a patient for the substance;
updating, by one or more electronic processors, the dosing model based at least in part on the dosing information;
executing, by one of the one or more electronic processors, a predictive model based on the updated dosing model to generate a dosing recommendation; and
providing, to the remote device via the communications network, the dosing recommendation.

2. The method of claim 1, wherein the dosing model comprises a non-linear mixed effects model.

3. The method of claim 1, wherein the predictive model comprises a Bayesian network.

4. The method of claim 1, wherein the dosing information comprises a patient characteristic and at least one of a dose amount, a dosing interval, or an exposure level.

5. The method of claim 4, wherein the dosing information further comprises at least two of a dose amount, a dosing interval, or an exposure level, and further comprising determining the one of the dose amount, the dosing interval, or the exposure level that was not received.

6. The method of claim 1, wherein the dosing recommendation comprises at least one of a dose amount, a dosing interval, or an exposure level.

7. The method of claim 1, further comprising:
receiving, via the communications network, second dosing information for a second patient for the substance;
determining, by one of the one or more electronic processors, whether the second dosing information may be used for a dosing model update based on demographic requirements for the dosing model;
responsive to determining the second dosing information may not be used for the dosing model update:
not updating the dosing model based on the second dosing information;
executing, by one of the one or more electronic processors, a predictive model based on the unmodified dosing model to generate a dosing recommendation; and
providing, via the communications network, the dosing recommendation.

8. The method of claim 7, wherein the demographic requirements comprise at least one of a country of residence, a country of treatment, a hospital, or a provider.

9. The method of claim 1, wherein updating the dosing model is performed in response to receiving the dosing information and wherein the dosing recommendation is for the patient.

10. The method of claim 1, wherein the dosing recommendation is for a second patient different from the patient.

11. The method of claim 1, wherein updating the dosing model is performed after a predetermined time period or after receiving a predetermined amount of dosing information.

12. The method of claim 1, further comprising iteratively:
receiving, via the communications network, additional dosing information for one or more patients; and
updating the dosing model based on the additional dosing information.

13. The method of claim 1, further comprising generating visualization information based on the dosing model and the predictive model, and transmitting the visualization information to the remote device via the communications network.

14. The method of claim 13, wherein the visualization information comprises blood concentration associated with the substance.

15. The method of claim 13, wherein the visualization information comprises statistical information associated with use of the substance for a demographic population, wherein the patient is a member of the demographic population.

16. A system comprising:
a network interface;
a non-transitory computer-readable medium; and
a processor in communication with the network interface and the non-transitory computer-readable medium, the processor configured to:
receive a dosing model for a substance;
receive, from a remote device via the network interface, dosing information for a patient for the substance;
update the dosing model based at least in part on the dosing information;
execute a predictive model based on the updated dosing model to generate a dosing recommendation; and
provide the dosing recommendation to the remote device via the network interface.

17. The system of claim 16, wherein the dosing model comprises a non-linear mixed effects model.

18. The system of claim 16, wherein the predictive model comprises a Bayesian network.

19. The system of claim 16, further comprising a data store, and wherein the data store comprises a plurality of data records, the data records comprising historical dosing information, and wherein the processor is further configured to store the dosing information in a data record in the data store, and update the dosing model based on data records in the data store.

20. The system of claim 16, wherein the dosing information comprises a patient characteristic and at least one of a dose amount, a dosing interval, or an exposure level.

21. The system of claim 20, wherein the dosing information further comprises at least two of a dose amount, a dosing interval, or an exposure level, and wherein the processor is configured to determine the one of the dose amount, the dosing interval, or the exposure level that was not received.

22. The system of 16, wherein the dosing recommendation comprises at least one of a dose amount, a dosing interval, or an exposure level

23. The system of claim 16, further comprising generating visualization information based on the dosing model and the predictive model, and transmitting the visualization information to the remote device via the network interface.

24. The system of claim 23, wherein the visualization information comprises blood concentration associated with the substance.

25. The method of claim 23, wherein the visualization information comprises statistical information associated with use of the substance for a demographic population, wherein the patient is a member of the demographic population.
